(19) United States
(12) Patent Application Publication
(10) Pub. No.: US 2005/0068578 A1
(43) Pub. Date: Mar. 31, 2005

(54) Random bit mask by-product file disk obscuring

(75) Inventors: Andrew R. Ferlitsch, Tigard, OR (US); Roy K. Chrisop, Camas, WA (US)

Correspondence Address: Robert D. Varitz;ROBERT D. VARITZ, P.C., 2007 S.E. Grant Street, Portland, OR, 97214, US

(73) Assignee: Sharp Laboratories of America, Inc.

(21) Appl. No.: 10/674,325

(22) Filed: Sep. 29, 2003

(51) Int. Cl. G06F 15/00

(52) U.S. Cl. 358/1.16

(57) ABSTRACT

A method for obscuring, relative non-volatile media, by-product, spool-associated data files which are created in the context of cooperative interaction between a computing device and an imaging device in relation to the handling of a document job file, where such interaction and handling include job-file data transit activities conducted in a transit zone which is operatively interposed these devices. The method features (a) locating and identifying, within such a zone, each such by-product file at least at a point in time which lies in a time span that is beyond the end of that file's operative utility, and (b), before any destructive alteration takes place with respect to that file, and within such a time span, and following the locating and identifying steps, applying a random bit mask obscuring process to the file.

### BACKGROUND AND SUMMARY OF THE INVENTION

This invention relates to temporary file obscuring, and in particular to random bit masking obscuring of print-job temporary by-product files, and in particular, spool-associated shadow and ghost files generated by a spooler typically somewhere within what is referred to herein as a transit zone that extends between a client computing device and a recipient device, or devices, such as a server and a printer (imager).

When a print job is created, either encrypted or not, at the location of a client computing device for ultimate transfer (transit) to a recipient device, such as a connected server, or downstream from such a server, a printing (or imaging) device, a client-side spooler typically generates one or more temporary by-product files, often referred to as spooler-associated shadow and/or ghost files. A shadow file is any file which is generated as a result of transmitting data, but otherwise is not a component of the data that is transmitted. For example, a shadow file might be a separate file which controls/records a transmission record. A ghost file is any file that is created as a result of transmitting data, where some element of the file is a component of the data transmitted. Such a file becomes a “ghost file” if, after the completion of data transmission, there is some residue of the file left in the storage of a non-volatile medium, such as a hard disk.

These by-product files, as has just been suggested, reside usually in a non-volatile memory medium such as a hard disk, and they may contain job data which, if accessed in a non-authorized fashion, can compromise the information-security of the associated print job. While such temporary files are usually “deleted” after their job utilities have been exhausted, conventional deletion practice does not actually render completely inaccessible job data contained in these files.

A similar situation exists at a downstream recipient server within the associated transit zone, wherein, again a spooler, receiving a job file from a print queue, may create the same kinds of temporary by-product. Here too, conventional deletion does not fill the bill, so-to-speak. Such a similar situation also exists sometimes at the location of an ultimate recipient of a job file, such as a printing/imaging device which may, in certain circumstances, occupy a transit zone which additionally includes an upstream server.

In the description herein of the present invention, all of the transit zone which lies downstream from a client computing device (located at the client side of the zone) is referred to as the server side of the zone.

The present invention successfully addresses these temporary, by-product, transit-zone, files-obscuring issues regarding spooler-associated ghost and shadow files, as well as other like files if so desired. It does so preferably on both the client-side and on the server-side of a document print-job transit zone by invoking certain special behaviors preferably in a conventional print processor, or in a raster image processor in a printer. Specifically, and according to preferred and best-mode practice of the present invention, with respect to a transit zone which terminates downstream with a server, a print processor, whether located at the client side or at the server side of a transit zone, is the device which is structured to perform the following invention-specified tasks:

1. It detects the associated spooler creation of such files, and tracks their media locations.

2. It locks such files against unwanted “deletion” by another process than that which it will ultimately implement itself in accordance with this invention.

3. It detects the point in time when the utility of the by-product file has ended.

4. And, when that time arrives, it implements a plural-stage random bit-masking process to the relevant files, thus to obscure job data within them.

These same enumerated activities are preferably performed by a raster image processor in a case where the downstream side of the transit zone is defined by a printing/imaging device.

While, as has just been stated, it is preferably a print processor or a raster image processor which implements a masking/obscuring function, other devices, such as a spooler, a printer driver, a device controller, and a port/language monitor may be employed in certain situations.

These and other various features and advantages which are offered and attained by practice of the present invention will become more fully apparent as the detailed description which now shortly follows is read in conjunction with the accompanying drawings.

### DESCRIPTION OF THE DRAWINGS

FIG. 1 is a simplified block/schematic view of the present invention as a whole showing a system which includes a client computing device, a downstream server, and a further-downstream print/imaging device.

FIG. 2 details, in block/schematic form, a client-side, print-processor-based implementation of the invention with regard to a by-product spooler-associated temporary file.

FIG. 3 details, also in block/schematic form, an illustration of a similar process which takes place at the server-side (the recipient-side) of a transit zone in the realm of a server.

FIG. 5 details, in block/schematic a client-side print-processor-based, driver-encrypted practice in accordance with the invention.

FIG. 6 is very similar to FIG. 5, except that it shows a similar activity taking place at the server or recipient side of a transit zone.

FIG. 7 provides another block/schematic illustration of practice of the invention which is reflective of activities that take place at either or both ends of the transit zone.

### DETAILED DESCRIPTION OF THE INVENTION

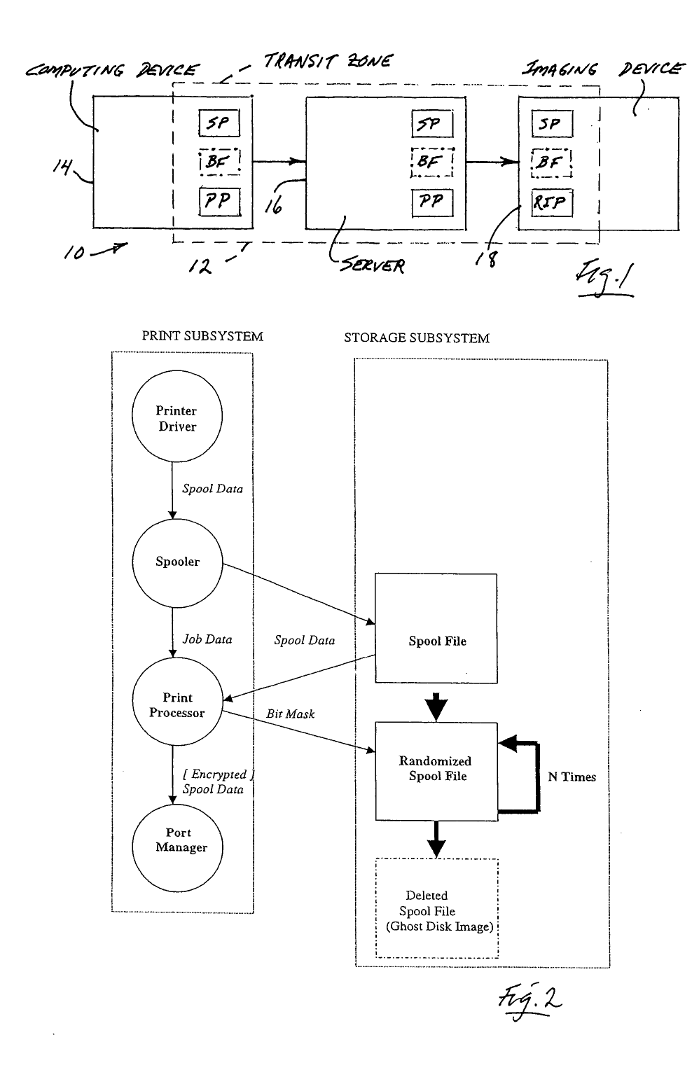

Turning now to the drawings, and referring first of all to FIG. 1, indicated generally at 10 is a printing/imaging system which includes, within a transit zone 12 which is represented by a dashed-line rectangle, a client computing device 14, a connected downstream server 16, and a connected, further-downstream imaging device 18 which, herein, is discussed in the context of being a printing device. While system 10 is thus illustrated with a single, downstream server, it should be understood (a) that such a server might not be present, or (b) that there might be a downstream plurality of such servers.

In system 10, a print job, encrypted or not, is created by computing device 14, and then transited within zone 12 initially to downstream server 16, and thereafter, from the server, to the further-downstream imaging device 18. Shown within computing device 14 and server 16 are three small blocks which bear the labels SP, BF and PP. In these two devices, SP represents a spooler, BF represents a by-product (ghost/shadow) file which is created by the associated server in conjunction with handling a transiting print job, and PP represents a print processor.

Within imaging device 18 there are three small rectangles which are labeled SP, BF and RIP. Here, SP continues to refer to a spooler, and BP to a by-product file. The letters RIP refer to a raster image processor.

With respect to the creation of an imaging job, or print job, within the realm of computing device 14, it is likely that the spooler therein will create one or several forms of the earlier-described by-product files which become resident in the device's non-volatile hard disk memory. Within server 16, handling by the server of this very same job may result in its spooler also creating one or more by-product files that also become lodged therein in the associated non-volatile memory. Finally, a job delivered to printing device 18 may also result in the associated spooler creating yet more by-product files which also become captured in a non-volatile memory medium.

According to practice of the present invention, and describing activity in the setting wherein a print processor is present, that print processor is given the task of detecting and tracking the media locations of such by-product files, and locking those files against unwanted deletion by any other process than that which the subject print processor will ultimately be called upon to implement itself, in accordance with this invention, to obscure such created by-product files. The print processor further detects the point in time when a by-product file's utility has ended, or become exhausted, and at that point in time it implements, in accordance with the invention, a plural-stage random bit-masking process to the relevant by-product files, thus effectively to obscure any recaptureable job data that might be contained within them. Preferably, this plural stage activity includes about seven stages of application of different random bit masks which achieve the desired obscuring end result.

If one simply substitutes the phrase “raster image processor” for “print processor” in the operational description just given immediately above, one will understand how a very similar process takes place within the realm of printing device 18 under the direction, control and responsibility of the associated raster image processor.

Further, in yet another kind of imaging device, such as in a fax machine, the activities specifically attributed herein to a print processor might be implemented by a device controller. Thus, and further considering what can be thought of as being shown generally in FIG. 1, it should be understood that the imaging device represented by block 18 might, in certain applications, be a fax machine, and that the small rectangle marked RIP might, in such a case, be a device controller rather than a raster image processor.

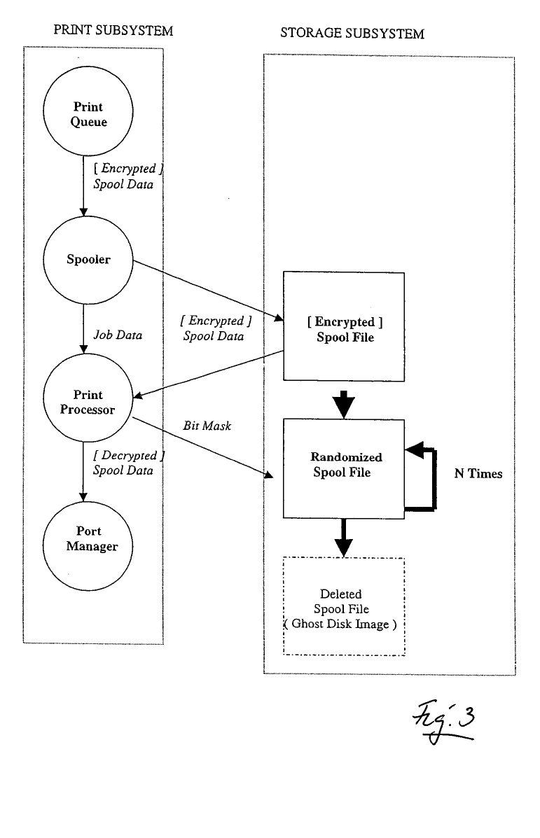

From this description, and by examining the high level system illustration given in FIG. 1, those generally skilled in this art should be fully armed and equipped to practice this invention. However, and in order to provide several specific and more detailed illustrations of implementation and practice of the invention, attention is now directed to FIGS. 2-6, inclusive.

Beginning with a narrative discussion which relates to FIG. 2, this figure specifically illustrates one form of client-side (of a transit zone), print-processor-based obscuring activity according to practice of the invention.

When a print job is created using a printer driver, the printer driver generates job and imaging information and spools this information to the print spooler. The driver may either generate the spool information as rendered print data (e.g., RAW), or as journaled data (e.g., EMF). In the Microsoft Windows® family of operating systems, the spool information is sent from the printer driver to the spooler through volatile memory using a Spooler API. It is assumed, given the construction of the computing and spooler API, that this transmission is effectively destroyed and unrecoverable ( i.e., does not need to be obscured).

The print spooler then writes the spool data to non-volatile memory for deferred despooling. The spool data written to non-volatile memory is generally referred to as a spool file. The print spooler may also generate additional spool-associated files. For example, in the Microsoft Windows® print subsystem, a spool header file ( i.e., a shadow file ) is created in the same spool directory with the same print job ID, but ending in the suffix .shd, where the spool file ends in the suffix .spl. This spool header file contains additional information, such as the print job requirements and job scheduling information.

The print spooler, immediately, or in a delayed manner, invokes the print processor to despool the print job to the port manager associated with the printing device. The print processor then reads the spool file. If the spool file is rendered (e.g., RAW), the print processor writes the spool data directly to the port manager. If the spool file is journaled, the print processor plays back the journaled data to the associated printer driver. The printer driver then converts the journaled data into rendered data, and spools the rendered data to the print spooler. The print spooler then invokes the print processor again, as in Windows NT/2K/XP®, to despool the rendered data to the port manager associated with the printer.

After the print processor has completed despooling the rendered data to the port manager, or has finished playback of the journaled data back to the driver, the spooler then deletes the spool file, and other associated spool files. In the case of EMF playback, the GDI subsystem deletes the EMF spool file, and in the case of Windows 95/98/Me®, deletes the EMF page files. Further describing this illustration of use of the present invention, the print processor optionally, but preferably, initially file locks the spool-associated files, such as:
RAW or EMF Spool File ( e.g., C:\windows\system\0001.spl)
Shadow File ( e.g., C:\windows\system\0001.shd)
EMF Page Files ( e.g., C:\temp\emf\001.tmp)

By file locking these files, the print processor keeps the underlying print/GDI subsystem from inadvertently deleting the file prior to the print processor obscuring the data. Once the print processor has completed processing the spool file, which may be marked by:
Reading the contents of the spool file
Despooling the contents to the port manager
Playing back the contents to the printer driver
   the print processor obscures the contents of the spool-associated files using suitable, plural, random bit mask generation overwrite techniques, and then deletes the spool-associated files.

In an encryption situation, the print processor, as an illustration, may perform by encrypting the spool data that is to be despooled to a recipient printing (imaging) device.

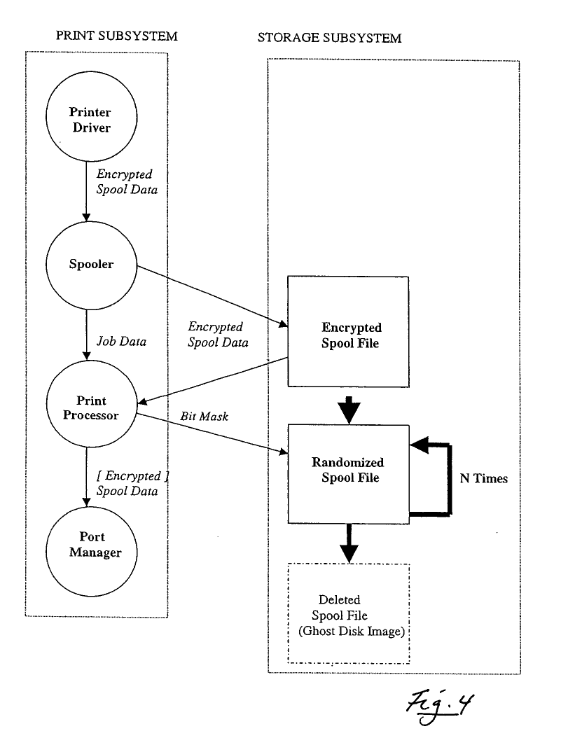

Shifting attention now to FIG. 3, here is illustrated a very similar obscuring practice performed in accordance with the invention, and specifically taking place on the print server side of a transit zone. If a print job is despooled to a print queue which is associated with a network printer (e.g., shared printer in Microsoft Windows® print subsystem), a copy of the spool data is again stored on the print server computing device (e.g., remote computing device) where the print queue is installed.

The print spooler on the print server, immediately, or in a delayed manner, invokes the print processor to despool the print job to the port manager associated with the printing device. The print processor follows the same despooling steps as described above regarding the client side. Additionally, the print processor on the print server preferably performs the same actions described above regarding optional file locking of the associated spool files, and obscuring of the data prior to file deletion.

In an alternate approach, the print job which is spooled to the print server is encrypted, and the print processor is a decrypting print processor which decrypts the print job prior to despooling to the printing device.

FIG. 4 in the drawings illustrates print-processor-based by-product file-obscuring as practiced by the present invention in a setting wherein a print driver has performed file encryption. In this illustration, unauthorized access to temporary ghost and/or shadow file information is further protected by the use of such encryption by a driver. Here, spool data generated by the printer driver and passed to the print spooler flows in an encrypted condition. The print spooler stores the encrypted spool data to non-volatile memory. Thereafter, and when by-product file utility has been exhausted, as determined by operation of a print processor, all of the above-described processor operations relating to file locking and obscuring, this time with respect to encrypted temporary data, are performed.

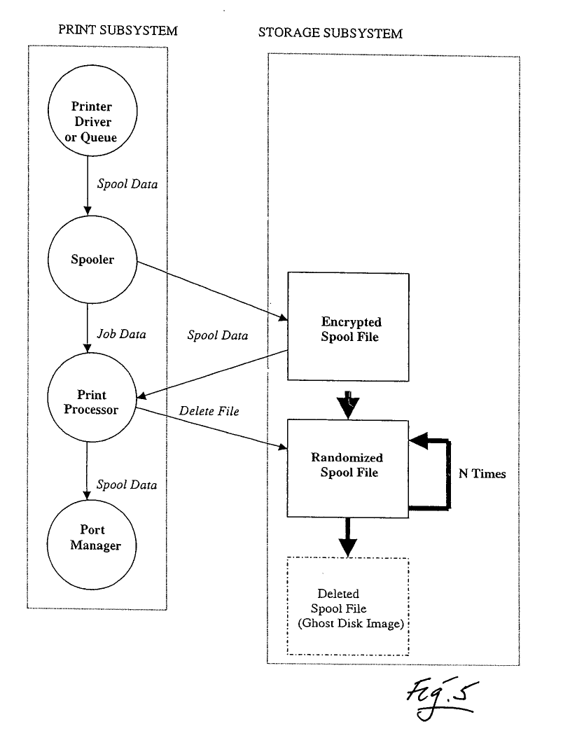

Directing attention now to FIG. 5, this figure pictures schematically both client-side and server-side obscuring of shadow and/or ghost by-product files in relation to a spool directory. In this illustration of practice of the invention, the spool directory where temporary spool associated files are stored is implemented as an encrypting and/or obscuring file system. In this case, the file system will automatically:
Encrypt data stored to non-volatile memory, and then decrypt when read back from memory.
Obscure the data (e.g., perform plural-stage bit-mask overwriting) prior to file deletion.

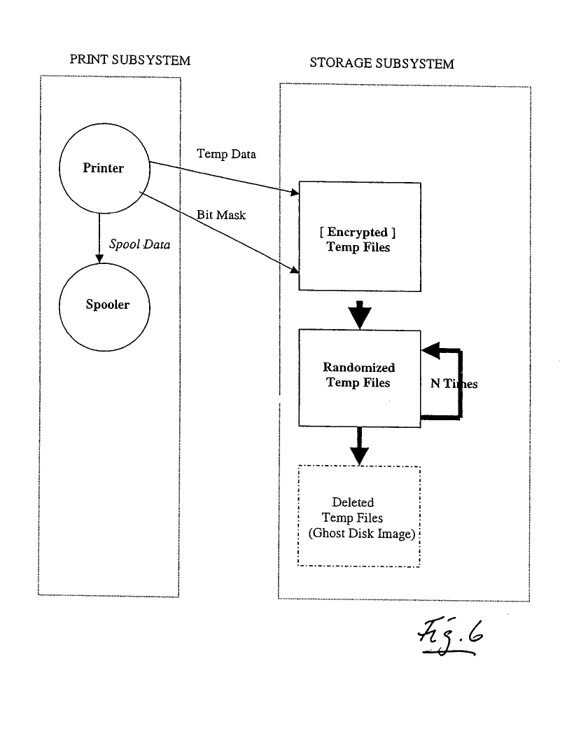

Finally now looking at FIG. 6, in this illustration, access to temporary by-product ghost and/or shadow file information is protected by the use of a random bit mask disk image-erasing printer driver as distinguished from a print processor. Here, the information in any temporary files that are generated by the printer driver, excepting the spool-associated files, during the construction of a print job is obscured in accordance with practice of the invention prior to deletion of these files.

Thus while several particular embodiments of the invention have thus been shown and described, it is appreciated that variations and modifications may be made without departing from the spirit of the invention.

1. A method for obscuring, relative to non-volatile media, by-product, spool-associated data files which are created in the context of cooperative interaction between a computing device and an imaging device, such as a printer, in relation to the handling of a document job file, where such interaction and handling include job-file data transit activities conducted in a transit zone which is operatively interposed these devices, said method comprising
locating and identifying within such zone, each such by-product file at least at a point in time which lies in a time span that is beyond the end of that file's utility, and before any destructive alteration takes place with respect to the file, and
within such time span, and following said locating and identifying, applying a random bit mask obscuring process to the file.

2. The method of claim 1, wherein said applying involves the recurrent application of plural, successive, different, random bit masks to the file.

3. The method of claim 1, wherein the created by-product, spool-associated files include files in the categories of ghost and shadow files.

4. The method of claim 3, wherein the step of applying a random bit mask process is performed by a print processor.

5. The method of claim 3, wherein the step of applying a random bit mask process is performed by a raster image processor.

6. The method of claim 3, wherein the step of applying a random bit mask process is performed by one of (a) a print processor, (b) a spooler, (c) a printer driver, (d) a raster image processor, (e) a port/language monitor, and (f) a device controller.

7. The method of claim 1, wherein at least one by-product, spool-associated file resides on the computing-device side of the transit zone.

8. The method of claim 1, wherein at least one by-product, spool-associated file resides on the imaging-device side of the transit zone.

9. The method of claim 4, wherein at least one by-product, spool-associated file resides on the computing-device side of the transit zone.

10. The method of claim 4, wherein at least one by-product, spool-associated file resides on the imaging-device side of the transit zone.

11. The method of claim 9, wherein the at least one by-product, spool-associated file is an encrypted file.

12. The method of claim 10, wherein the at least one by-product, spool-associated file is an encrypted file.

13. The method of claim 1, wherein said locating, identifying and applying steps are associated with controlling activities that are engaged in by one of a print processor and a raster image processor, which processor also performs an additional function of by-product file-locking in a manner assuring a controlling role for the processor in relation to by-product file obscuring.

14. The method of claim 13, wherein at least one by-product, spool-associated file resides on the computing-device side of the transit zone.

15. The method of claim 13, wherein at least one by-product, spool-associated file resides on the imaging-device side of the transit zone.
